(19) United States
(12) Patent Application Publication
(10) Pub. No.: US 2026/0051781 A1
(43) Pub. Date: Feb. 19, 2026

(54) ARRANGEMENT OF A STATOR WITH A POLYMER HOUSING FOR A DYNAMOELECTRIC MACHINE, PRODUCTION PROCESS, AND USE OF THE ARRANGEMENT

(71) Applicant: INNOMOTICS GMBH, Nürnberg (DE)

(72) Inventors: Tobias Katzenberger, Bad Königshofen (DE); Bastian Plochmann, Neustadt an der Aisch (DE); Klaus Büttner, Hollstadt (DE); Klaus Kirchner, Ostheim (DE); Matthias Warmuth, Windshausen (DE)

(21) Appl. No.: 18/994,431

(22) PCT Filed: Jul. 5, 2023
(86) PCT No.: PCT/EP2023/068558

§ 371 Date: Jan. 14, 2025

(30) Foreign Application Priority Data
Jul. 14, 2022 (EP) 22184845.0

(51) Int. Cl. H02K 5/02; H02K 15/0273; H02K 15/148

(52) U.S. Cl. CPC H02K 5/02; H02K 15/0273; H02K 15/148; H02K 2213/03

(57) ABSTRACT

The invention relates to a process which is intended for producing an arrangement comprising a stator (STT) and a housing (OCS) for a dynamoelectric machine and in which a number of stator laminations (SMS) are put together to form a laminated core (SMP). The production process comprises:—arranging the stator laminations (SMS) in a stack along an axial direction to form a laminated core (SMP) and-applying a composite polymer (GPF) to at least the radial outer side of the laminated core (SMP) such that one or more applied layers of the filled composite polymer (GPF) at least partially form(s) the housing (OCS). A composite polymer is a polymer in the form of a matrix in which particles are embedded. In addition, the invention also relates to an arrangement comprising a stator (STT) and a housing (OCS) of a dynamoelectric machine and also the use thereof for a process for producing or processing foodstuffs, pharmaceutical products or cosmetic products.

This application is the National Stage of International Application No. PCT/EP2023/068558, filed Jul. 5, 2023, which claims the benefit of European Patent Application No. EP 22184845, filed Jul. 14, 2022. The entire contents of these documents are hereby incorporated herein by reference.

### BACKGROUND

The present embodiments relate to a method for producing an arrangement including a stator and a housing for a dynamoelectric machine. The present embodiments also relate to an arrangement including a stator and a housing of a dynamoelectric machine, and the use of such an arrangement for a process for producing or processing foodstuffs, pharmaceutical products, or cosmetic products.

Electrical or electrodynamic machines, such as electric motors, may be encapsulated in an aluminum housing after the insertion of the copper winding and impregnation. The housing serves as an enclosure for the motor (e.g., providing protection against environmental influences and acting as a heat sink). Herein, the metal housing or aluminum housing that often has cooling fins to promote heat transfer to the convective air is shrunk in an energy-intensive process.

A spindle motor with a coated laminated core and a dedicated housing is already known from US 6 753 628 B1.

It is already known from WO 2022/017653 A1 to fix stator laminations to each other on a radial inner side using a composite polymer.

Small shaft heights (e.g., a short distance between the center of the motor shaft and a mounting surface arranged parallel to the motor shaft), for example, are sold very cheaply on the market due to price pressure; this makes economical production increasingly challenging while maintaining quality requirements of the motor.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, based on the problems and disadvantages of the prior art, a method may be provided such that production costs are reduced while maintaining the same quality and function.

In one embodiment, a method. In other embodiments, a corresponding arrangement including a stator and a housing of a dynamoelectric machine, as well as the use of such an arrangement for a process for producing or processing foodstuffs, pharmaceutical products, or cosmetic products are provided.

The present embodiments are well-suited for the use of the arrangement in a process for producing or processing foodstuffs, pharmaceutical products, or cosmetic products, because the use according to the present embodiments of the composite polymer makes it particularly easy to achieve a design for hygienically demanding processes. For example, hygienically advantageous encapsulation of the stator laminations is easy to realize.

More specifically, the present embodiments provide that, after the stator laminations have been arranged in a stack along an axial direction to form a laminated core, a filled composite polymer, which may also be referred to as a gap filler medium in more functional terminology, is applied to at least the radial outer side of the laminated core, such that one or more applied layers of the filled composite polymer at least partially form the housing.

The filled composite polymer is a polymer composite material. This provides the filled composite polymer is a composite material made of two or more materials bonded together. The filled composite polymer is a particle composite material, a particle composite, or a dispersion material. Herein, particles are, for example, embedded in a matrix of polymer material or a polymer or plastic.

The replacement according to the present embodiments of the housing by a corresponding embodiment of the laminated core significantly reduces the production costs of the dynamoelectric machines or motors. To date, cost reductions in the production process for these machines have been achieved by conventional minor design changes, which save material and may shorten the production time. The present embodiments take a different approach, by which a previously important component may be replaced.

The housing according to the present embodiments, formed by the outer contour of the laminated core, which is provided with a layer of the gap filler medium, meets all mechanical requirements.

The outer contour of the laminated core is protected against external influences, such as gases, liquids, (e.g., corrosive substances) by the filled composite polymer. The filled composite polymer creates a visually seamless and smooth surface, giving the product a high-quality appearance. The housing produced at least partially from the filled composite polymer represents a cost-effective and high-quality solution in terms of production technology.

According to a development, at least 50% to 100% of a radial housing wall thickness of the housing surrounding the laminated core consists of one more applied layers of the filled composite polymer.

According to a development, the filled composite polymer has a viscosity of at least 1000 mPas at room temperature. Herein, the room temperature may be the ambient temperature in the room where the processing takes place. This temperature may be around 15°-22° C. (e.g., 17°-19° C.).

According to a development, 0 wt. % to 5 wt. % of a solvent is added to the filled composite polymer in order to reduce the viscosity. This provides that, for example, no solvent needs to be added to the filled composite polymer in order to reduce viscosity, so that, for example, no edge receding may occur. Edge receding refers to the surface tension-induced retraction of a liquid layer (e.g., a layer of paint) away from radii. Uniform wetting and encapsulation with a layer of the same thickness as would occur, for example, on a flat surface is a successful way of avoiding edge receding. To achieve this, the base material may, for example, be very highly viscous and thixotropic.

To enable spray application, the filled composite polymer may, for example, be rendered sprayable by a rapidly evaporating solvent. In one embodiment, the added solvent may be selected and measured such that significant proportions evaporate during spraying, and the desired viscosity is achieved on contact with the surface.

In a development of the present embodiments, the filled composite polymer contains particles. Herein, the particles include at least one of the following ingredients: thermally conductive particles (e.g., including boron nitride (BN) and/or aluminum oxide (Al2O3) and/or quartz flour and/or fused silica); flame-retardant particles (e.g., aluminum hydroxide (Al(OH)3); electrically insulating particles (e.g., mica).

A development of the present embodiments provides that the filled composite polymer is a thixotropic liquid. When applied by spraying, even with a suitable composition with a solvent, the layer of the filled composite polymer becomes highly viscous immediately upon contact and also adheres to radii, maintaining a homogeneous layer thickness.

In one embodiment, a development of the present embodiments provides that a thixotropic agent is added to the filled composite polymer to impart thixotropic properties prior to application. A suitable quantity of an inorganic thickener may be added in order to impart thixotropic properties.

A development of the present embodiments provides that the filled composite polymer is formed as a highly filled composite polymer. The highly filled composite polymer may be formed with a particle content of up to 80 wt. %.

The present embodiments also relate to an arrangement including a stator and a housing of a dynamoelectric machine in which a number of stator laminations are arranged adjacent in a stack along an axial direction to form a laminated core, where the stator laminations have an axial gap between them at least in regions. At least a radial outer side of the laminated core is provided with a layer of a filled composite polymer so that the applied layer of the filled composite polymer at least partially forms the housing. This arrangement may be produced according to an embodiment of a method.

A development of the present embodiments provides that at least some stator laminations have at least one fin portion that is continued radially outward relative to the adjacent circumferential contour and extends over at least a portion of the circumference.

In order to produce the cooling fin structure on the final outer contour of the motor, the laminated core itself (e.g., the individual stator laminations) may have corresponding outer contour punching. This realization of the cooling fins may be achieved without additional effort, allowing the stator laminations to dissipate the heat output from the stator without additional resistance (e.g., from transitions between the laminations and a shrunk-on housing).

Further, the present embodiments include the use of the arrangement or the use of the method for a process for producing or processing foodstuffs, pharmaceutical products, or cosmetic products.

### BRIEF DESCRIPTION OF THE DRAWINGS

The above-described properties, features, and advantages of this invention and the manner in which they are achieved will become clearer and more understandable in the light of the following description and embodiments that are described in more detail in the context of the drawings. The following description does not restrict the invention to the embodiments contained therein. The same components or parts may be identified with the same reference symbols in different figures. It should be understood that an embodiment may also be any combination of the above claims or the embodiments described here with the features of the respective claim.

FIG. 1 is a schematic simplified representation of a method according to an embodiment as a flow chart;

FIG. 2 is a schematic simplified three-dimensional representation of a laminated core without fins; and

FIG. 3 is a schematic simplified three-dimensional representation of a laminated core with fins.

### DETAILED DESCRIPTION

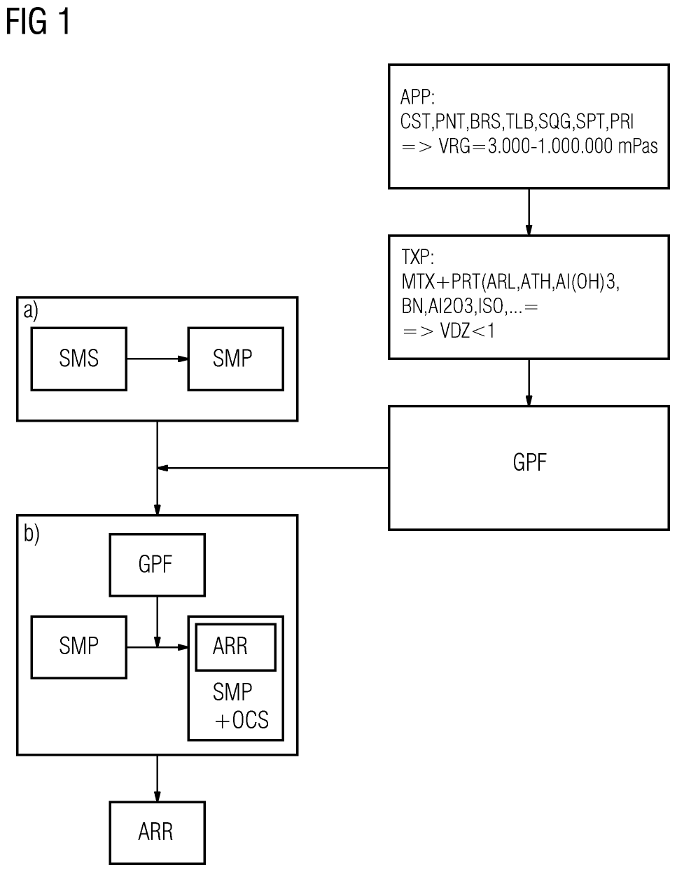

FIG. 1 shows a schematic simplified representation of a method for producing an arrangement ARG including a stator STT and a housing OCS for a dynamoelectric machine as a flow chart in a sequence of acts (a), (b).

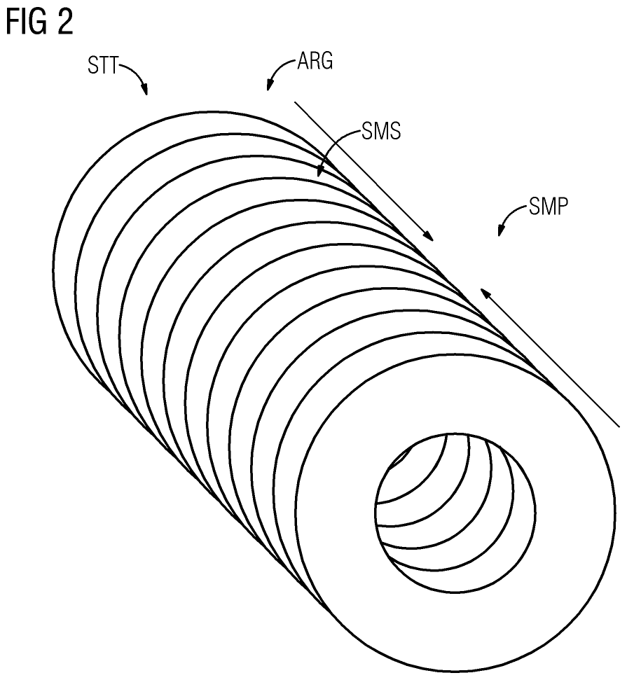

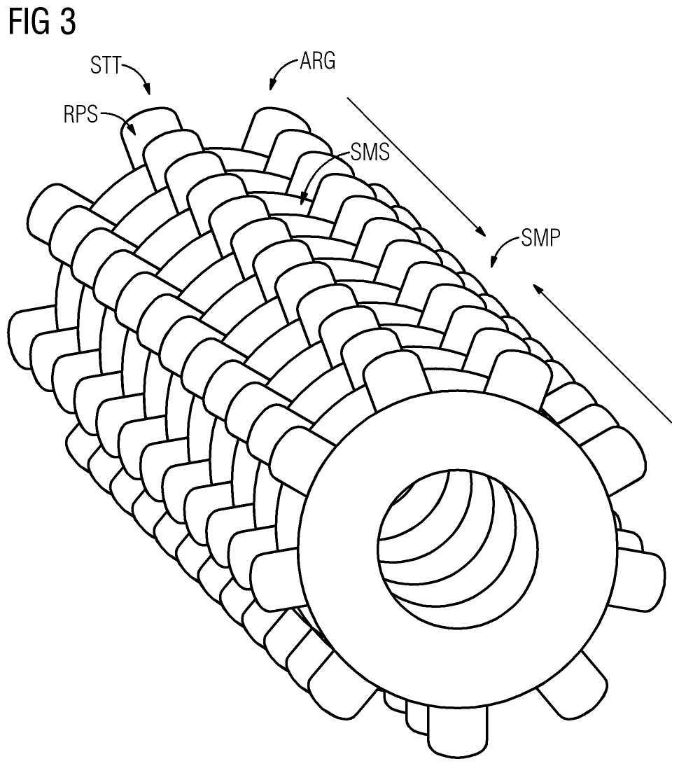

The stator STT includes a number of stator laminations SMS that are assembled to form a laminated core SMP, as also shown in FIGS. 2, 3. In FIG. 3, the individual stator laminations SMS have a fin portion RPS that is continued radially outward relative to an adjacent circumferential contour and extends over at least a portion of the circumference.

Act (b) provides that a filled composite polymer GPF is applied to at least a radial outer side of the laminated core SMP so that one or more applied layers of the filled composite polymer GPF form the outer housing OCS of the dynamoelectric machine at least partially (e.g., completely).

Before step (b) is initiated, it is first defined how the application process APP is to take place. Various options are available for this. Application may take place using: casting CST, painting PNT, brushing BRS, thick-layer brushing TLB, squeegeeing SQG, spatula-tucking SPT, pressing-in PRI. Depending on this, a viscosity range (VRG) of the filled composite polymer (GPM) of 3,000-1,000,000 mPas is defined. For this purpose, it is provided that, for application by casting CST, painting (PNT), and brushing BRS, the viscosity VSC is in the range of up to 10,000 mPas, and that, for application by spatula-tucking or pressing-in, the viscosity is defined in the range from 10,000 mPas.

Starting from the determined viscosity range VRG, the viscosity of the filled composite polymer GPM is established by admixing thickening agents and/or admixing particles PRT and/or by imparting thixotropic properties TXP. The filled composite polymer GPM is produced as a highly filled composite polymer GPM with a particle content PRT of up to 80 wt. %. Thixotropic properties may be achieved by adding an inorganic thickener ATH or by adding 0.1-5 wt. % (e.g., 0.1-2 wt. %) fumed silica ARL. In this way, the filled composite polymer GPF is obtained as a thixotropic liquid that is a highly viscous material at room temperature, without solvents, and that, after application, remains dimensionally stable, similarly to a paste, and herein wets and encapsulates substrate edges and substrate curves in a homogeneous layer.

The filled composite polymer GPF used may be a gap filler with, for example, epoxy, PU, or PEI as a matrix. Herein, this filled composite polymer GPF is solvent-free and may optionally be filled with, for example, thermally conductive particles (e.g., BN, Al2O3, quartz flour, fused silica), flame-retardant particles (e.g., Al(OH)3), or electrically insulating particles (e.g., mica, and those mentioned above). Solvents for reducing viscosity may not be used in potting/encapsulation applications, as it is not possible to remove the solvent from thick layers without creating pores, foaming effects, and general imperfections. A viscosity range of 3,000-1,000,000 mPas is advantageous, where flowable (e.g., castable, paintable, dispersible, but not sprayable) filled composite polymers GPF tend to be at the lower end of the range, and higher viscosity polymers from approximately 10.000 mPas may be applied by spatula-tucking or pressing-in.

A crucial aspect of spray processing is that a high-viscosity system (e.g., from the gap filler or potting compound class) may be made low-viscosity (e.g., <5000 mPas) for a very short time (e.g., significantly shorter than conventional paints) from application to the desired wetting of the substrate, so that it is possible to spray an additive top layer onto an irregular substrate surface (e.g., cooling fin radii and sheet edges of the outer contour) without having to accept the disadvantages of conventional paint systems (e.g., capillary action between the sheeting, edge receding). Rendering the formulation “sprayable” meets the need for design freedom of the outer housing contour.

A temporary reduction in viscosity and the enabling of sprayability may be achieved through two combined measures. 1. Imparting thixotropy to the gap filler/potting material, which may be produced based on Aerosil (e.g., fumed silica; an inorganic additive) in amounts of approximately 0.1-2 wt. % or by incorporating inorganic thickeners, as described, for example, in application WO2015197647A1 from the company BYK (Altana Group).

Both methods result in the viscosity being significantly reduced under shear (e.g., to the value of the starting material without a thixotropic agent), but, after a few seconds of rest, it increases to a value that may be higher by a factor of 10-1000, depending upon the form and proportion of the thixotropic additive. 2. In order to lower the viscosity value of the starting product, a compatible solvent (or a mixture of different solvents) may be used (e.g., 5-40 wt. %), which has a low evaporation index (e.g., =relatively fast evaporation, definition is the relative evaporation time compared that of diethyl ether with 1). This reduces the mixed viscosity in the resting state of the material (e.g., thixotropic additive-solvent-mixture as required to a sprayable viscosity (<5000 mPas)).

During the actual spraying process, the material experiences a high shear force that is dependent on the nozzle geometry, whereby the thixotropy causes the overall viscosity to drop to the resting state value. After the application of a homogeneous sprayed-on layer (e.g., 10-60 μm), two viscosity-increasing effects overlap within seconds. The increase in viscosity due to the thixotropy starts in seconds (e.g., the sprayed layer “settles down”), and the solvent mixture with a low evaporation index (e.g., VDZ<1) evaporates quickly from the layer and thus progressively and sustainably increases the viscosity back to the original level of the gap filler/potting compound. The sprayed-on material does not remain in its low-viscosity state long enough to penetrate significantly into the gaps between the sheets through capillary action or to recede from the edges (e.g., “edge receding”) or to form drips. After the first layer has partially dried (e.g., evaporation of a significant proportion of the solvent, so that the layer has a dry and matt appearance), a further layer may be applied within a few minutes. Due to the high “dry and resting viscosity” (e.g., =paste-like), the workpiece does not have to be stored in a rolling position. Instead, vertical and overhanging surfaces may also be sprayed. A number of layers may be applied in this method as required to achieve the desired coating effect (e.g., optically dense, corrosion resistance, smooth surface, etc.). The use of a two-component resin as a basis enables curing to take place at room temperature (or a slightly higher temperature if necessary). This eliminates the need for further thermal curing and creates a flexible faster and CO2-friendly process.

In one possible embodiment, a two-component gap filler material from the company Elantas (e.g., component A: MC336; component B: W363 TX) was used; an inorganic thickener from the company BYK was used to impart thixotropic properties to the material (both companies are part of the Altana Group). Component A: MC336 and component B: W363 TX were mixed in a weight ratio of 100:7.5, and an additional 15 parts by weight MEK were used as a readily volatile solvent (e.g., low evaporation index of 6).

Spraying is carried out with a commercially available compressed air spray gun. Approximately 30-50 μm may be applied per layer. Herein, the layer thickness, spray pattern, spray angle, etc. may be individually adjusted via pressure, nozzle geometry, feed rate, and spray distance. A drying time of approximately 3 minutes (e.g., significant evaporation of the solvent (MEK)) results in a matt surface at room temperature. Then, the next layer may be sprayed on. From a triple coating, the sheet contour is covered by a homogeneous and continuous surface in this way, so that, when viewed from the outside, it resembles a thin plastic enclosure in terms of its optical and physical properties. The aforementioned combined measures prevent the material from entering the gaps between the sheets through capillary action, edge receding, and the formation of runs and drips. Accordingly, it is possible to apply the coating using a spraying process regardless of variance. The low layer thickness during a spraying process allows the solvent to diffuse quickly from the layer without creating imperfections (e.g., pores). Depending on the required surface quality and optical features, further layers or thicker individual layers may be applied. This may be set via process parameters. A housing produced in this way is partially cured within a few hours at room temperature (e.g., touchable or non-adhesive) and fully cured after approximately 48 hours at room temperature. Optionally, this time may be reduced to a few hours by increasing the temperature (e.g., with an IR emitter).

For the filled composite polymer GPM, the class of materials including potting resins and gap fillers may be used, as these have suitably high viscosity due to their high filler content. In one embodiment, a combination of thixotropy and solvent addition (e.g., with a suitable evaporation index) is used to render the aforementioned materials suitable for additive application (e.g., sprayable) but to provide the highly viscous properties quickly after application. Herein, application in a plurality of thin layers may be provided such that the solvent content may diffuse out of the layers without creating pores. This partial drying and the thickening process that occurs within seconds due to thixotropy successively provides a seamless and continuous layer over the discontinuous substrate (e.g., individual sheet contours). This cannot be achieved with conventional paint systems.

Other methods for higher-viscosity systems are, for example, spatula-tucking, squeegeeing, or “thick-layer brushing.” These methods are somewhat more difficult to apply due to the contours and are not easy to automate.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for producing an arrangement comprising a stator and a housing for a dynamoelectric machine, in which a number of stator laminations are assembled to form a laminated core, the method comprising:
arranging the number of stator laminations in a stack along an axial direction, such that a laminated core, is formed; and
applying a curable filled composite polymer to at least a radial outer side of the laminated core such that one or more applied layers of the curable filled composite polymer at least partially form the housing.

2. The method of claim 1, wherein applying the curable filled composite polymer comprises spraying the curable filled composite polymer.

3. The method of claim 1, wherein at least 50% to 100% of a radial housing wall thickness of the housing is formed from one or more applied layers of the curable filled composite polymer.

4. The method of claim 1, wherein the curable filled composite polymer has a viscosity of at least 1000 mPas at room temperature.

5. The method of claim 1, further comprising adding 0 wt. % to 5 wt. % of solvent to the curable filled composite polymer in order to reduce viscosity.

6. The method of claim 1, wherein the curable filled composite polymer contains particles, the particles comprising
thermally conductive particles, flame-retardant particles, electrically insulating particles, or any combination thereof.

7. The method of claim 1, wherein the curable filled composite polymer is a thixotropic liquid.

8. The method of claim 1, further comprising:
imparting thixotropic properties to the curable filled composite polymer, the imparting comprising adding a thixotropic agent prior to application.

9. The method of claim 8, wherein
imparting thixotropic properties to the curable filled composite polymer comprises adding an inorganic thickener.

10. The method of claim 9, comprising: wherein imparting thixotropic properties to the curable filled composite polymer comprises adding 0.1-5 wt. %, fumed silica.

11. The method of claim further comprising:
defining an application process the defined application process being casting, painting, brushing, thick-layer brushing, squeegeeing, spatula-tucking, or pressing-in;
defining a viscosity range of the curable filled composite polymer of 3,000-1,000,000 mPas depending on the defined application process wherein the method provides a definition of viscosity in a range of up to 10,000 mPas for application by casting painting, or brushing and provides a definition of viscosity in a range of from 10,000 mPas for application by spatula-tucking or pressing-in; and
establishing the defined viscosity of the curable filled composite polymer using admixing thickening agents, admixing particles, or the admixing thickening agents and the admixing particles, by means of imparting thixotropic properties, or a combination thereof.

12. The method of claim 1, wherein the curable filled composite polymer is formed as a highly-filled composite polymer with a particle content of up to 80 wt. %.

13. The method of claim 2, wherein the curable filled composite polymer is subjected to preparatory steps to make the curable filled composite polymer sprayable prior to spray application, the preparatory steps comprising:
imparting thixotropic properties using an inorganic additive; and
adding a solvent with an evaporation index VDZ<1.

14. An arrangement comprising:
a stator and a housing of a dynamoelectric machine, in which a number of stator laminations are arranged adjacent in a stack along an axial direction, such that a laminated core, is formed,
wherein the number of stator laminations have an axial gap between the number of stator laminations at least in some regions, and
wherein at least a radial outer side of the laminated core is provided with a layer of a filled composite polymer so that the layer of the filled composite polymer forms the housing

15. (canceled)

16. The arrangement of claim 14, wherein at least some stator laminations of the number of stator laminations have at least one fin portion that is continued radially outward relative to an adjacent circumferential contour and extends over a least a portion of the circumference.

17. A method comprising:
using an arrangement for a process for producing or processing foodstuffs, pharmaceutical products, or cosmetic products, the arrangement comprising a stator and a housing of a dynamoelectric machine, in which a number of stator laminations are arranged adjacent in a stack along an axial direction, such that a laminated core is formed, wherein the number of stator laminations have an axial gap between the number of stator laminations at least in some regions, and wherein at least a radial outer side of the laminated core is provided with a layer of a filled composite polymer so that the layer of the filled composite polymer forms the housing.

18. The arrangement of claim 14, wherein the housing of the stator of the dynamoelectric machine is made of a curable, thixotropic filled composite polymer.

19. The method of claim 6, wherein the thermally conductive particles include boron nitride, aluminum oxide, quartz flour, fused silica, or any combination thereof,
wherein the flame-retardant particles include aluminum hydroxide, and
wherein the electrically insulating particles include mica.

20. The method of claim 10, wherein imparting thixotropic properties to the curable filled composite polymer comprises adding 0.1-2 wt. % fumed silica.
